(19) United States
(12) Patent Application Publication
(10) Pub. No.: US 2024/0394305 A1
(43) Pub. Date: Nov. 28, 2024

(54) SYSTEMS AND METHODS FOR INDEXING MEDIA CONTENT USING DYNAMIC DOMAIN-SPECIFIC CORPUS AND MODEL GENERATION

(71) Applicant: GLOSSAI LTD., Tel Aviv (IL)

(72) Inventors: Eyal KOREN, Rehovot (IL); Adi PAZ, Herzeliya (IL); Ofer FAMILIER, Tel Aviv (IL)

(21) Appl. No.: 18/693,217

(22) PCT Filed: Sep. 19, 2022
(86) PCT No.: PCT/IB2022/058821

§ 371 Date: Mar. 19, 2024

Related U.S. Application Data
(60) Provisional application No. 63/245,893, filed on Sep. 19, 2021.
(60) Provisional application No. 63/295,894, filed on Jan. 2, 2022.

(51) Int. Cl. G06F 16/71; G06V 10/77; G06V 20/40

(52) U.S. Cl. CPC G06F 16/71; G06V 10/7715; G06V 20/47

(57) ABSTRACT

Systems and methods for processing and indexing media content for summarization and generating insights. A media source provides audio/video files to a media pre-processor to enhance the quality of an audio-video stream. A media processor comprises a video feature extractor, an audio feature extractor and a text feature extractor to extract base features from the audio-video stream at various time intervals. Higher-level features are extracted by executing Artificial Intelligence algorithms over the base features. A feature combining and indexing unit combines the extracted base features and higher-level features for time-stamping and indexing of the audio-video stream. Insightful output is generated based on the input content. The audio-video stream indexed by time and features are stored in a database along with the generated insights. A data explorer allows efficient searching, editing and compression of the audio/video files.

### FIELD OF THE INVENTION

The disclosure herein relates to systems and methods for processing the media content. In particular, systems and methods are described for processing and indexing the media content for summarization and insights generation.

### BACKGROUND OF THE INVENTION

In recent years, digital distribution of media content and their access on devices connected to a network has become common. The media content including video and/or audio may contain a variety of content that may be for entertainment, informational or educational purposes. The videos may include recordings, reproduction or streaming of moving visual images that may contain sound and/or music. The current media discovery and consumption process has limitations and does not provide a rich experience to the users. The current technology does not provide any indexing of the video stream that can allow a viewer to directly jump to a segment of interest within the video. The viewer has to manually run through the video using the video player controls to watch the segment of interest. The existing tools does not allow users to skim through the video by skipping the boring and uninterested parts.

Further, the current technology does not provide an easy access to the viewer to collate the parts of interest within the video and generate a smaller and compressed file. This task can be done using specific video editing software and require expertise and considerable time.

Furthermore, the lack of structural information within the video limits the ability to perform comprehensive search for the videos. The conventional video searching algorithms uses the title, subtitles, manually tagged keywords, video description, etc. to search for the videos presenting lot of undesired content to the user. Moreover, the searched video may have the desired content in between, however, there is no way for the user to discover it and jump directly to the useful part.

Few existing technologies allow the users to manually annotate the audio and video files and generate a table of contents (ToC) for each file, however, this requires huge manual effort to label all the media content and populate the database. Further, each user has its own perception of labeling the media content. For example, a statement or a dialogue in the video file may be positive or negative for the user based on its perception. Similarly, the labeling of facts, opinions, and/or emotions about specific content and/or moments within the video will be biased on the user's thought process.

There are various approaches for DL/ML language models which work with text. A general purpose model may be trained on a very large corpus in order to be able to interpret the context, jargon and lingo of as many domains as possible. Alternatively or additionally a more specific model may be trained for each domain specifically.

It is noted that a general purpose model may produce good results in some cases. Nevertheless, it has been found that the results are typically worse than those obtained by a domain specific model. Furthermore, the general purpose models tend to be very heavy, resulting in a resource hungry solution, both in terms of memory and processing time.

On the other hand, the domain specific model approach may create a specific solution to a specific problem with smaller, faster models and may generate better results (as long as the model is used on the appropriate documents). However, the domain specific model approach arises from the need to support a large number of document types and training models for every type of document one might encounter in practice is close to impossible.

Thus, there is a need for an improved system which allows automatic indexing of the media content and make it more searchable for the users. Further, the system should make the media content more accessible for the users allowing editing and creation of smaller files with desired content. Moreover, the need remains for an approach which may combine both the general model and the domain specific approaches into a single, dynamic solution. The invention described herein addresses the above-described needs.

### SUMMARY OF THE EMBODIMENTS

In one aspect of the invention, a system for processing and indexing the media content for summarization and insights generation is disclosed. The system includes a media source, a media pre-processor, a media processor, a database and a data explorer.

In another aspect of the invention, the media source is configured to provide an audio/video file comprising an audio-video stream to the media pre-processor to enhance the quality of the audio-video stream. The pre-processed audio-video stream is provided to the media processor for indexing and insights generation. The media processor comprises a video feature extractor, an audio feature extractor and a text feature extractor to extract base features from the audio-video stream at various time intervals. The base features are extracted from the audio-video stream using artificial intelligence algorithms.

In a further aspect of the invention, the extracted base features are used to extract higher-level features. These higher-level features are built by executing various algorithmic methods such as Artificial Intelligence algorithms over the base features for example. The media processor also comprises a feature combining and indexing unit for combining the extracted base features and higher-level features. The audio-video stream is time-stamped and indexed with the extracted features. The indexing of the audio-video stream allows searching and extraction of specific moments from the audio-video. An insights generator of the media processor is responsible for generating an insightful output based on the input content.

In a yet another aspect of the invention, the database stores the audio-video stream indexed by time and features along with the generated insights. The data explorer allows efficient searching, editing and compression of the audio/video files for specific requirements.

In a further aspect of the invention, a data explorer is configured to allow efficient searching, editing and compression of the media content.

As appropriate, the media content comprises one or more of a video stream, an audio stream or a combination thereof.

As appropriate, the format of the video stream may be one or more of Audio Video Interleave (AVI), Moving Picture Experts Group (MPEG)-4 (MP4), Apple QuickTime Movies (e.g., a MOV file), Microsoft WMV, Flash Video (FLV), Audio Video Interleave (AVI), Matroska Multimedia Container (MKV), WebM, and combinations thereof.

As appropriate, the media pre-processor enhances the quality of the media content through one or more of the processes including removing background noise, image scaling, removing blur, deflicking, contrast adjustment, color correction and stereo image enhancement & stabilization.

As appropriate, the media pre-processor is further configured to separate the video stream from the audio stream.

As appropriate, the feature extractor comprises one or more of a video feature extractor, an audio feature extractor and a text feature extractor for extracting the video, audio and text features from the media content, respectively.

As appropriate, the higher-level features are extracted from the base features by executing an Artificial Intelligence algorithm or a classic algorithm over the base features.

As appropriate, the feature combining and indexing unit aligns the output features to the video stream and the audio stream of the media content along with a timestamp.

As appropriate, the media processor can be trained to extract features from the media content using a Machine Learning algorithm.

As appropriate, the data explorer is further configured to access one or more moments in the media content by sorting and filtering according to the output features.

As appropriate, the data explorer is further configured to generate a compressed video by combining the accessed one or more moments.

As appropriate, the media processor comprises a deep learning or a machine learning language model for generating the insightful output based on the input media content.

According to an aspect of the invention, the media processor is further configured to generate a dynamic domain-specific corpus and a domain specific model for generating the insightful output.

As appropriate, the media processor is further configured to automatically train the dynamic domain-specific corpus and the domain specific model.

According to another aspect of the invention, the media processor is configured to generate and train the dynamic domain-specific corpus and the domain specific model by identifying a document type of the media content, inspecting the database if the domain specific model was previously created for the document type, enhancing the previously created domain specific model using the media content, generating the domain specific model by creating a domain-specific corpus for the document type of the media content, enhancing the domain-specific corpus by fetching documents from the corpus based on the document type of the media content and generating and training the domain specific model using the enhanced corpus.

As appropriate, the domain-specific corpus is created from a subset of a general corpus stored in the database.

In another aspect of the invention, method for processing and indexing a media content is disclosed. The method comprises providing a media content by a media source and enhancing the quality of the media content by a media pre-processor. The method also includes extracting one or more base features from the enhanced media content at various time intervals of the media content by a media processor and extracting one or more higher-level features from the base features by the media processor. The method further includes combining the extracted base features and higher-level features to generate output features for time-stamping and indexing of the media content by a feature combining and indexing unit, generating an insightful output based on the input media content by an insights generator and storing the media content in a database with time-stamping, indexing and the insightful output.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 illustrates a system 100 for automatic indexing and insights generation of a media content according to an aspect of the invention;

FIG. 2 illustrates a schematic block diagram 200 illustrating various components for automatic indexing and insights generation of a media content according to an aspect of the invention;

FIG. 3 is a block diagram illustrating the output generated from processing the video content;

FIG. 4 illustrates a flowchart showing method steps for automatic indexing and insights generation of a media content according to an aspect of the invention;

FIG. 5A illustrates an exemplary representation of a processed and indexed audio-video web conversation;

FIGS. 5B and 5C illustrate exemplary representations of compressed audio-video conversation of the processed web conversation of FIG. 5A;

FIG. 6A illustrates an exemplary representation of a processed and indexed movie stream;

FIG. 6B illustrates exemplary representation of compressed audio-video stream of the processed movie stream of FIG. 6A;

FIG. 7 illustrates an exemplary method for high level application of the invention;

FIG. 8 illustrates an exemplary processed video with indexing and time stamping; and

FIG. 9 is a flowchart illustrating a method dynamic domain-specific corpus and model generation.

### DESCRIPTION OF THE SELECTED EMBODIMENTS

Aspects of the present disclosure relate to systems and methods for processing and indexing the media content for summarization and insights generation. In particular, the disclosure relates to the use of machine learning algorithms for audio, video and text feature extraction from the media content. The parts of the media content are time-stamped and labelled by combining the extracted features. The labelling allows data exploration through searching, editing and compressing the media content for specific requirements.

In particular examples of the system, the content of audiovisual files may be compressed in a useful manner so as to render the content more accessible. For example such a compressed, or squeezed file, may remove less pertinent content and retain only the content that is deemed more pertinent to the consumer. Additionally or alternatively, less pertinent content may be retained at a lower resolution or lower quality so as to reduce file size.

In other examples of the system, the content of the audiovisual files may be divided into chapters and sub-chapters each with its own chapter heading such that the video may be more readily navigable.

In still other examples of the system, a search engine may be provided for audiovisual content by categorizing and indexing the content of the file according to various characteristics such as content type, speaker, tone of voice or the like such as described herein.

As required, the detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

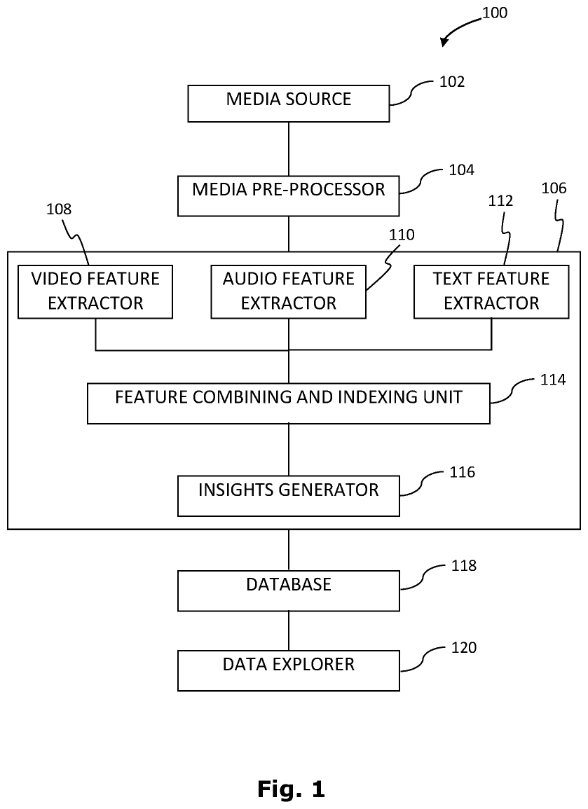

Reference is now made to FIG. 1, which is a system 100 for automatic indexing and insights generation of a media content according to an aspect of the invention. The system 100 comprises a media source 102, a media pre-processor 104, a media processor 106, a database 118 and a data explorer 120.

The system 100 may be used to process audio and/or video files stored in a media source 102. The media source 102 may be a local memory of a computing machine such as a personal computer, a laptop, a mobile phone, a tablet, a paging device and the like. The media source 102 may also be a digital media player designed for the storage, playback, or viewing of digital media content. Alternatively, the digital media files may be received from a networked device such as a server, a router, a network PC, a mobile phone and the like. Further, the digital media files may be received through broadcast or live streaming using a TV or a communication device. Also, the media file may be a recorded web conversation using online platforms such as Skype, Whatsapp, Google Meet, Microsoft Teams, Zoom Meetings, Cisco Webex Meet, etc.

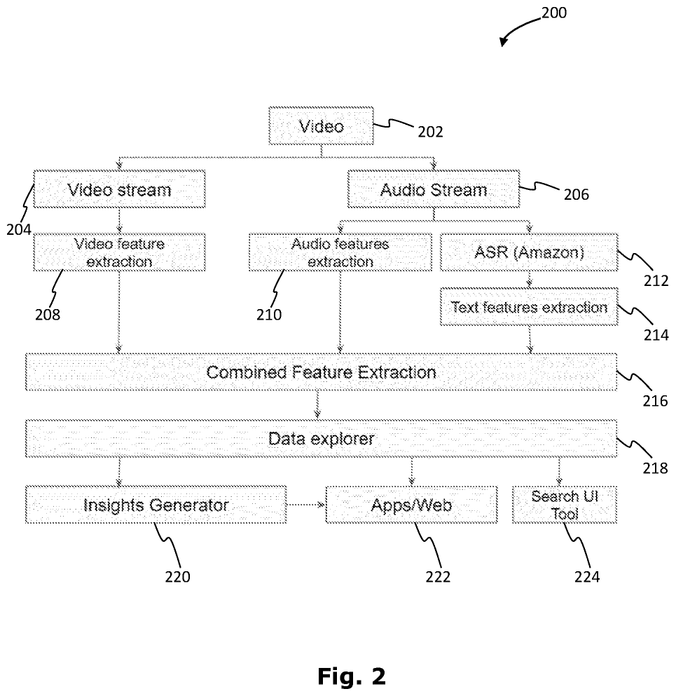

The system 100 may be used to process a video file 202 comprising a video stream 204 and an audio stream 206 as shown in FIG. 2. The video file 202 may be of any video file format including, but not limited to, Audio Video Interleave (AVI), Moving Picture Experts Group (MPEG)-4 (MP4), Apple QuickTime Movies (e.g., a MOV file), Microsoft WMV, Flash Video (FLV), Audio Video Interleave (AVI), Matroska Multimedia Container (MKV), WebM and so forth.

The media pre-processor 104 is used to enhance the quality of the video stream 204 and the audio stream 206 by removing background noise, image scaling, removing blur, deflicking, contrast adjustment, color correction, stereo image enhancement & stabilization, etc. The media pre-processor 104 also separates a video stream 204 and an audio stream 206 from the input video 202 for further processing.

The media processor 106 comprises a video feature extractor 108, an audio feature extractor 110 and a text feature extractor 112 for extracting the video, audio and text features from the video stream 204 and the audio stream 206. The video feature extractor 108 extracts base features from the video stream 204 using artificial intelligence algorithms. For example, the video feature extractor 108 may perform actor separation, speaker separation, number of actors determination, body pose determination, facial expression determination of the actors, location determination, background objects and background environment determination, type of animals/birds determination, presentation methods (slide, object, others), etc. Similarly, the audio feature extractor 110 also extracts base features from the audio stream 206. For example, the audio feature extractor 110 may determine what is said, to which sentence does the word belong to, differentiate between spoken words and background sound, words spoken by different speakers, monologue or dialogue, sound of animals/birds, sound of objects, speech rate, pitch and amplitude level, etc. The text feature extractor 112 extracts text features from the video stream 204 and the audio stream 206. For example, the text feature extractor 112 extracts information from the title, subtitles, text presented in the video stream 204. The text feature extractor 112 may also extracts text from the audio stream 206 using automatic speech recognition software (ASR), for example Amazon ASR 212, to extract the spoken words.

The system 100 may employ any of the known artificial intelligence algorithms without limiting the scope of the invention. For example, the system 100 may use classification algorithms like Naïve Bayes, Decision Tree, Support Vector Machines (SVM), K Nearest Neighbours (KNN), etc. The system 100 may also use Regression Algorithms like Linear Regression, Lasso Regression, Multivariate Regression, etc. The Clustering Algorithms like K-Means Clustering, Fuzzy C-means algorithm, Hierarchical Clustering algorithm may also be used for the purpose.

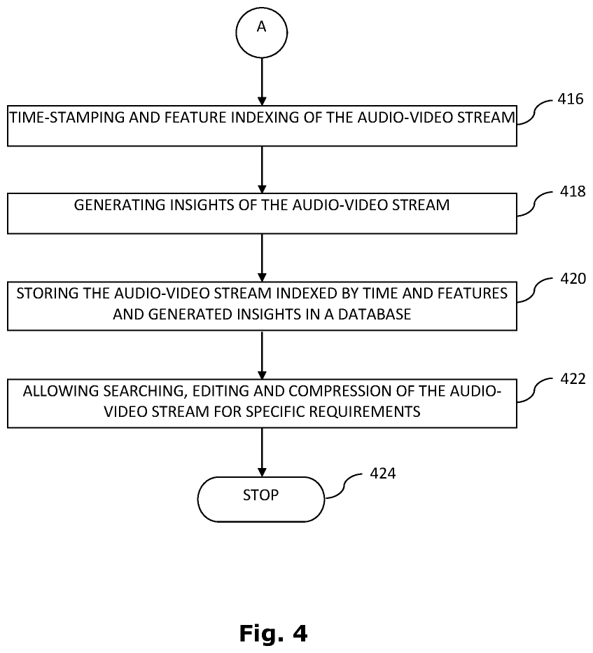

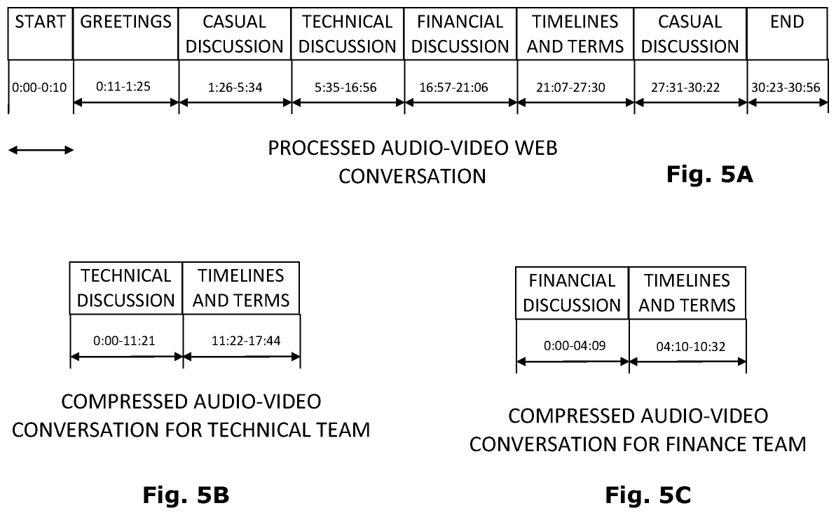

The base features extracted by the video feature extractor 108, audio feature extractor 110 and the text feature extractor 112 are then used to extract higher-level features. These higher-level features may be built by executing some AI or classic algorithms over the base features. For example, emotion features are extracted from the facial expression, body pose, speech rate, pitch and amplitude level extracted above. In case of a discussion, the base features may also be used to determine the content of the discussion at various time intervals. For example, as shown in FIG. 5A, a discussion between a client and a service provider may be classified depending upon the content discussed at various time intervals as greetings, casual discussion, technical discussion, financial discussion, timelines and terms of the work discussed during the web conversation. The base features may also be used to determine the emotional content of the video 202 portion as happiness, surprise, neutral, sad, tragic, violent, etc. as shown in FIG. 6A. These extracted features are at the backbone of the ability to conduct smart search within the video and build automatic analysis over the video on a second, word, sentence, monologue and other layers.

The extracted base features and the higher-level features are combined by a feature combining and indexing unit 114 of the processing unit 106. For example, emotion features are extracted from video, voice and text. The final emotion score is built by combining the relevant features that have been extracted. The extracted features are then aligned to the video stream 204 and the audio stream 206 and indexed along with the timestamp as shown in FIGS. 5A and 6A. The indexing of the video 202 allows searching and extraction of specific moments from the video 202.

An insights generator 116 is responsible for generating an insightful output based on the input content. An output might contain a summary of the content, separation to topics, automatic extraction of a presentation (if relevant), skillsets analysis, emotional state analysis and others. The insights generator 116 is modular. Specific insights modules might be executed for specific content, while others might be skipped. The selection of which modules to run is done automatically after an initial pass to detect the type of the content (multiple types might be relevant for a specific video/audio).

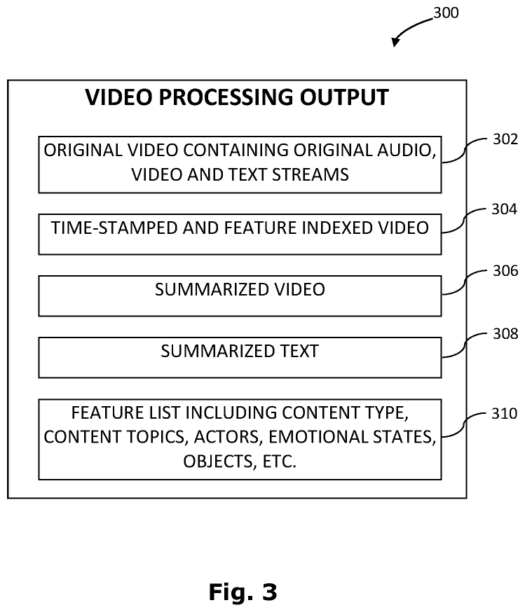

FIG. 3 illustrates a video processing output 300 generated by the insights generator 116 after processing the video 202. The output 300 may contain one or more of the time-stamped and feature indexed video 304, summarized video 306, summarized text 308 and a list of features 310 like content type, content topics, actors in the video 202, emotional states, background objects, etc. The output 300 and the feature list may be provided as a table of content (ToC) for easy access of a user.

The generated output 300 may be stored in a database 118. The database 118 may a local storage of video playback device or a networked element. Further, the output 300 may also be stored in a cloud computing environment.

In a non-limiting example of the current invention, the database 118 is created having video/audio indexed by time (milliseconds) with the below exemplary parameters (or more) per each record:
What is said
Who said it
What type of word is it (i.e. filler)
To which sentence does this word belong to
What is the type of sentence (i.e. question, positive/negative, others)
To which monologue does this word belong to
What is the pitch level used
What is the amplitude level used
What is the speech rate used
What is the facial expression expressed by the speaker and audience
What is the emotion expressed
What is presented (slide, object, others)

These parameters may be at the backbone of the ability to conduct smart search within the video and build automatic analysis over the video on a second, word, sentence, monologue and other layers.

The system 100 may be trained to extract features from the video 202. The system 100 may employ any of the known Machine Learning algorithms as per the requirement. The algorithm can be a Supervised Learning algorithm which consists of a target/outcome variable (or dependent variable) which is to be predicted from a given set of predictors (independent variables). Exemplary Supervised Learning algorithms include Regression, Decision Tree, Random Forest, KNN, Logistic Regression etc. Alternatively, algorithm can be a Reinforcement Learning algorithm using which the machine is trained to make specific decisions. Exemplary Reinforcement Learning algorithm includes Markov Decision Process.

The Data Explorer 120 (or 218) exposes an API to allow easy querying of data. Moments in the video 202 can be accessed by sorting and filtering according to the extracted features. A higher-level syntax allows querying by using a more natural description of what is being looked for. For example, instead of looking for happiness>0.90, the user can filter by typing “is happy”. Alternatively, the option is looking for moments using natural language queries. In addition, the Data Explorer API 120 (or 218) provides functionality for looking for words/sentences that have the same meaning as what is searched for, looking for people mentioned, searching for topics and more, both in the spoken text or displayed text (for example in presentation). The data explorer 120 (or 218) may be provided as a web interface 222 or search user interface (UI) tool 224.

The video 202 may be edited and compressed for specific viewing by the user. The user may search specific moments from the video 202 using the feature list 310 and extract the relevant portions of the video 202. A short and compressed video may be generated comprising only the extracted relevant moments. For example, FIGS. 5B and 5C illustrate exemplary representations of compressed audio-video conversation of the processed web conversation of FIG. 5A. The compressed video in FIG. 5B illustrate only the portions required for the technical team while the compressed video in FIG. 5C illustrate only the portions required for the finance team. Similarly, FIG. 6B illustrates exemplary representation of compressed audio-video stream of the processed movie stream of FIG. 6A. The compression of the video as per the requirement saves a lot of time of the user instead of watching the whole video 202.

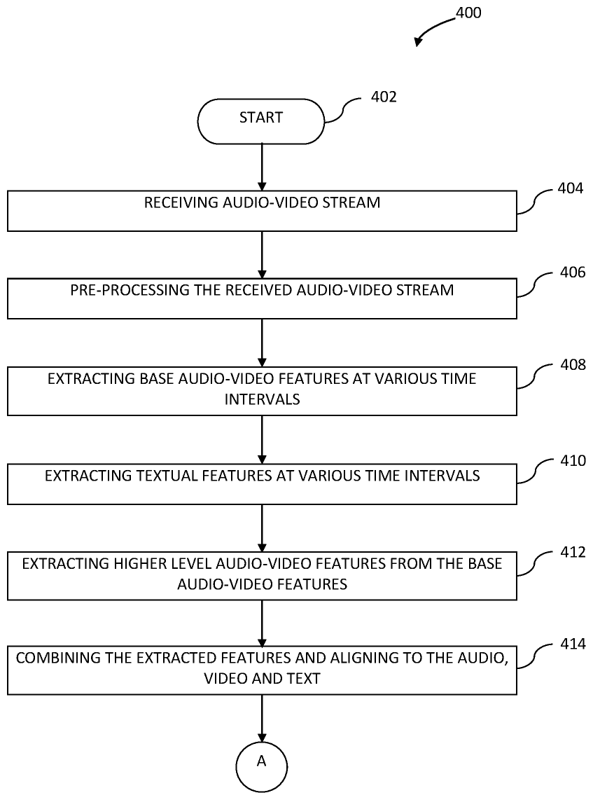

Referring to FIG. 4 which illustrates a flowchart 400 showing method steps for automatic indexing and insights generation of a media content according to an aspect of the invention. The process starts at step 402 and the video containing audio-video stream is received at step 404. The received audio-video stream is pre-processed by the media pre-processor 104 at step 406 to enhance the quality of the audio-video stream. At step 408, the base features are extracted from the audio-video stream at various time intervals by the video feature extractor 108 and the audio feature extractor 110. The base features are extracted from the audio-video stream using artificial intelligence algorithms. At step 410, the text feature extractor 112 may also extract textual features using the information from the title, subtitles, text presented in the video stream 204. The text features may also be extracted from the audio stream 206 using automatic speech recognition software (ASR), for example Amazon ASR 212, to extract the spoken words.

At step 412, the extracted base features are used to extract higher-level features. These higher-level features may be built by executing some AI algorithms over the base features. Additionally or alternatively, such features may be obtained using classic algorithms. At step 414, the extracted base features and higher-level features are combined by the feature combining and indexing unit 114 of the processing unit 106. For example, emotion features are extracted from video, voice and text. The final emotion score is built by combining the relevant features that have been extracted. The extracted features are then aligned to the audio-video stream. At step 416, the audio-video stream is time-stamped and indexed with the extracted features. The indexing of the audio-video stream allows searching and extraction of specific moments from the audio-video. At step 418, the insights are generated for the audio-video stream comprising the summarized video 306, summarized text 308 and a list of features 310 like content type, content topics, actors in the video 202, emotional states, background objects, etc. The audio-video stream indexed by time and features is stored in the database 118 at step 420. The generated insights may also be stored in the database 118. At step 422, the audio-video stream may be allowed to be searched, edited and compressed for specific requirements. The user may search specific moments from the audio-video stream using the feature list 310 and extract the relevant portions of the audio-video stream. A short and compressed video may be generated comprising only the extracted relevant moments. The process stops at step 424.

### Dynamic Domain-Specific Corpus and Model Generation

The media processor 106 may employ DL/ML language models which enable automatic generation of a summary, abstract or keyword description of full-length input content. A system and method are introduced for automatically and dynamically building and training a domain specific corpus and a domain specific model to suit the need of the specific document that is currently being processed. It is particularly noted that once generated, the dynamically built models may be reused should the same document type be detected in the future.

It will be appreciated that dynamic corpus generation is useful in its own right as outlined above. Moreover, where required, the step of building and training a dynamic corpus may be used as a preliminary step before indexing media content as it may improve indexing by providing more nuanced weightings for domain specific words, sentences and paragraphs.

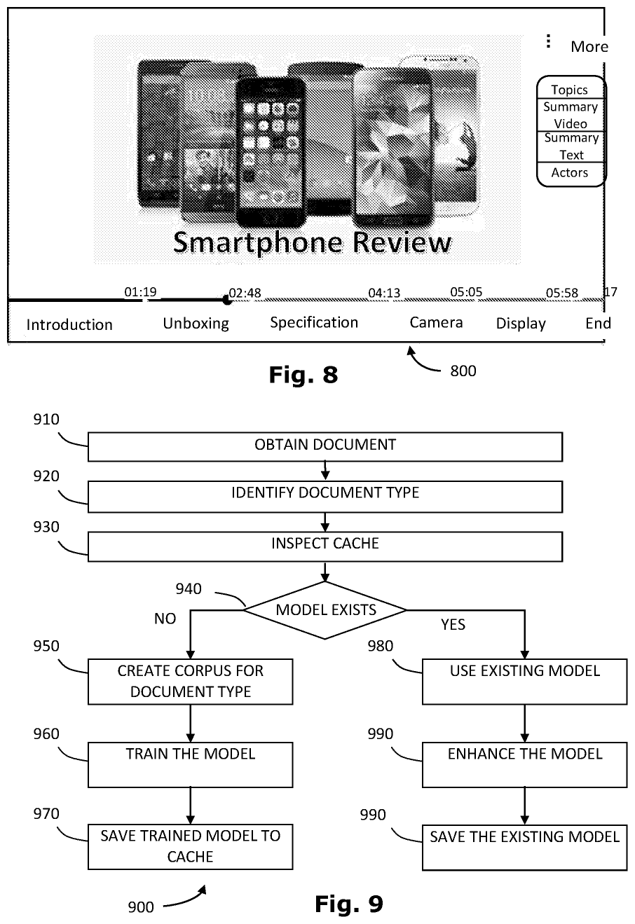

Referring to FIG. 9 which provides a flowchart illustrating a method for dynamic domain-specific corpus and model generation. The method may include various steps including: obtaining a document 910, identifying the document type 920, inspecting a cache 930, creating a corpus 950, training the models 960, and saving the trained models 970.

The step of identifying the document type 920 may include identifying a document type by finding the most important words that can in the subject document. It has been found that keyword identification may be enabled by the use of an algorithm such as LSA, LDA, TextRank or any other applicable algorithm, or multiple algorithms. Other methods will occur to those skilled in the art.

The step of cache inspection 930 is provided to check if a model has already been created for the specific document type, step 940. Accordingly, various embodiments of the method may create a document type signature which is used to check if a model exists. Such a signature may be calculated according to the output of the identifying step. The signature may be calculated using word embeddings/synonyms, for example. Once a signature is available, a lookup is performed to see if a model has already been built for this topic, or a close enough topic.

It is a particular feature of the method that, if a pre-generated model has been found for the document type, it will be used at step 980. Furthermore, at step 990, the pre-generated model may be enhanced using the data gathered from the new document.

If no pre-generated model is found for the document type, then the dynamic system is operable to generate a new model in the corpus creation step 950.

In case a new document type has been detected, a new model must be generated dynamically for handling it. Such as generation step may include: building a corpus to train the model on. For example, a corpus may be based on a subset of a locally available general corpus. Additionally or alternatively, a large corpus covering many topics may be available. An example for such a corpus might be “The Pile” or a subset of it.

Other corpuses can be generated and used.

It is a particular feature of the generated corpus that it is pre-indexed.

Accordingly, related documents may be fetched from the corpus, based on the words found in the document type identification step. The fetched documents may be used to construct the new corpus needed for training a domain-specific model.

Additionally or alternatively a corpus may be enhanced or generated by scraping relevant documents from the internet according to the words found in the document type identification step. In this case, an internet scraping module may be provided to access relevant documents as required.

Once a corpus has been generated, the step 960 of training the models using this corpus proceeds by using a model training module. For example, the corpus can be used for ASR optimizations per specific topic, classic NLP techniques as well as ML/Deep approaches. Additionally or alternatively, the dynamic corpus input may enable automatic generation of a summary, abstract or keyword description of full length input content. Still other methods will occur to those skilled in the art.

It is noted that even where machine learning is used to train models from scratch, the corpus may be used to train such models, to transfer learning thereby shortening the training time for larger models.

Once the model training step provides a useful model, the generated models are saved to a model cache and labeled with a topic signature to allow lookup to be performed in the future.

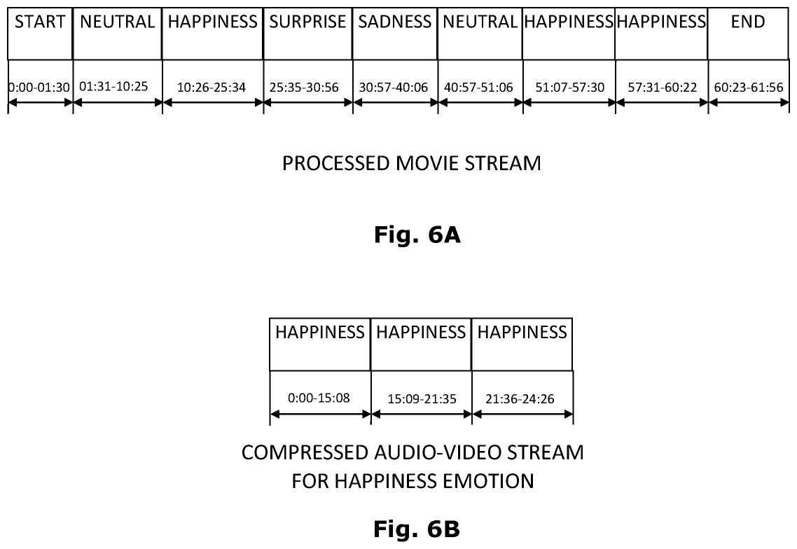

Reference is now made to FIG. 7 which illustrates an exemplary method 700 for high level application of the invention. The process starts at step 702 and a user login to a media indexing and insights generation application. The application may be available in form of an online web portal providing a user interface for login and accessing the application. Alternatively, the user may download the application on his smartphone from an app store. Also, the application may be a software code locally stored in a communication device, e.g. laptop, desktop, smartphone, pager, tablet, server, etc. of the user.

At step 706, the user uploads a video from the media source 102 comprising audio and video stream to the application. At step 708, the uploaded video is automatically processed by the application as per the method steps discussed above. The uploaded video may be processed by the application automatically on uploading the video. Alternatively, the process may be initiated by the user through an action, e.g., click of the cursor, hovering of the mouse, pressing key combination on the keypad, voice or gesture initiated, etc. At step 710, the processed video output is generated along with the original uploaded video. The processed video output may contain one or more of the items discussed above in FIG. 3.

The generated video output is presented to the user for review and the user verifies the output at step 712. In case the generated output is determined to be correct at step 714, the video indexing and insights generation process is completed at step 718. Else, the user manually corrects the indexing and/or summary according to his satisfaction at step 716. Finally, at step 720, the output video may be uploaded on a server or Internet for access to other users. The process stops at step 722.

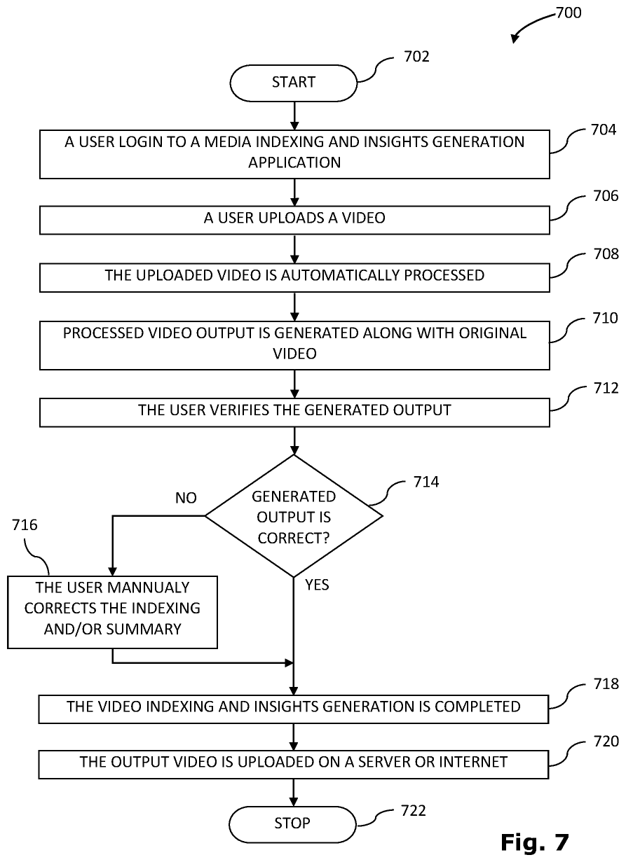

An exemplary video 800 with indexing and time stamping is illustrated in FIG. 8. The indexing may enable a user to directly jump on the desired section. The video also provides various features, such as “Topics”, “Summary Video”, “Summary Text” and “Actors” (speakers) to the user for easy access.

The systems and methods explained above may allow efficient searching of the audio/video files and compression of the audio/video for specific requirements.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A system for processing and indexing media content, the system comprising:
a media source configured to provide the media content;
a media pre-processor configured to enhance the quality of the media content;
a media processor configured to process the enhanced media content for summarization and insights generation, the media processor comprising:
a feature extractor configured to:
extract one or more base features from the enhanced media content at various time intervals of the media content; and
extract one or more higher-level features from the base features;
a feature combining and indexing unit configured to combine the extracted base features and higher-level features to generate output features for time-stamping and indexing of the media content; and
an insights generator configured to generate an insightful output based on the input media content;
a database for storing the media content with time-stamping, indexing and the insightful output.

2. The system of claim 1 further comprising a data explorer configured to allow efficient searching, editing and compression of the media content.

3-5. (canceled)

6. The system of claim 2, wherein the media pre-processor is further configured to separate the video stream from the audio stream.

7. The system of claim 1, wherein the feature extractor comprises one or more of a video feature extractor, an audio feature extractor and a text feature extractor for extracting the video, audio and text features from the media content, respectively.

8-12. (canceled)

13. The system of claim 1, wherein the media processor comprises a deep learning or a machine learning language model for generating the insightful output based on the input media content.

14-17. (canceled)

18. A method for processing and indexing a media content, the method comprising:
providing a media content by a media source;
enhancing the quality of the media content by a media pre-processor;
extracting one or more base features from the enhanced media content at various time intervals of the media content by a media processor;
extracting one or more higher-level features from the base features by the media processor;
combining the extracted base features and higher-level features to generate output features for time-stamping and indexing of the media content by a feature combining and indexing unit;
generating an insightful output based on the input media content by an insights generator; and
storing the media content in a database with time-stamping, indexing and the insightful output.

19. The method of claim 18, wherein the media content comprises one or more of a video stream, an audio stream or a combination thereof.

20. The method of claim 19, wherein the format of the video stream may be one or more of Audio Video Interleave (AVI), Moving Picture Experts Group (MPEG)-4 (MP4), Apple QuickTime Movies (e.g., a MOV file), Microsoft WMV, Flash Video (FLV), Audio Video Interleave (AVI), Matroska Multimedia Container (MKV), WebM, and combinations thereof.

21. The method of claim 18, wherein enhancing the quality of the media content includes one or more of removing background noise, image scaling, removing blur, deflicking, contrast adjustment, color correction and stereo image enhancement & stabilization.

22. The method of claim 18, wherein extracting the base features comprises extracting one or more of video features, audio features, text features or a combination thereof.

23. The method of claim 18, wherein extracting the higher-level features include executing an Artificial Intelligence algorithm or a classic algorithm over the base features.

24. The method of claim 18 further comprises aligning the output features to the video stream and the audio stream of the media content along with a timestamp.

25. The method of claim 18 further comprises training the media processor for extracting features from the media content using a Machine Learning algorithm.

26. The method of claim 18 further comprises accessing one or more moments in the media content by sorting and filtering according to the output features.

27. The method of claim 26 further comprises generating a compressed video by combining the accessed one or more moments.

28. The method of claim 18, wherein using a deep learning or a machine learning language model by the media processor for generating the insightful output based on the input media content.

29. The method of claim 28 further comprising generating a dynamic domain-specific corpus and a domain specific model by the media processor for generating the insightful output.

30. The method of claim 29 further comprising training the dynamic domain-specific corpus and the domain specific model by the media processor.

31. The method of claim 30, generating and training the dynamic domain-specific corpus and the domain specific model comprises:
identifying a document type of the media content;
inspecting the database if the domain specific model was previously created for the document type;
enhancing the previously created domain specific model using the media content;
generating the domain specific model by creating a domain-specific corpus for the document type of the media content;
enhancing the domain-specific corpus by fetching documents from the corpus based on the document type of the media content; and
generating and training the domain specific model using the enhanced corpus.

32. The method of claim 31, wherein creating the domain-specific corpus comprises creating from a subset of a general corpus stored in the database.
